(19) United States
(12) Patent Application Publication
(10) Pub. No.: US 2022/0379283 A1
(43) Pub. Date: Dec. 1, 2022

(54) PHOSPHORUS ADSORBENT

(71) Applicants: NATIONAL UNIVERSITY CORPORATION KOBE UNIVERSITY, Hyogo (JP); FujiClean Co., Ltd., Aichi (JP); THE CHUGOKU ELECTRIC POWER CO., INC., Hiroshima (JP)

(72) Inventors: Satoshi ASAOKA, Hiroshima (JP); Kohei KAWAKAMI, Gifu (JP); Tsuyoshi ICHINARI, Aichi (JP); Hiroyuki SAITO, Aichi (JP); Takahito OIKAWA, Hiroshima (JP); Kenichi WATANABE, Hiroshima (JP); Hideaki NOHARA, Hiroshima (JP)

(73) Assignees: NATIONAL UNIVERSITY CORPORATION KOBE UNIVERSITY, Hyogo (JP); FujiClean Co., Ltd., Aichi (JP); THE CHUGOKU ELECTRIC POWER CO., INC., Hiroshima (JP)

(21) Appl. No.: 17/642,798

(22) PCT Filed: Sep. 2, 2020
(86) PCT No.: PCT/JP2020/033172

§ 371 Date: Mar. 14, 2022

(30) Foreign Application Priority Data
Sep. 19, 2019 (JP) 2019-170334

(51) Int. Cl. B01J 20/02; B01J 20/30; C02F 1/28

(52) U.S. Cl. CPC B01J 20/02; B01J 20/30; C02F 1/28; C02F 2101/105

(57) ABSTRACT

An object of the present invention is to provide a phosphorus adsorbent that is inexpensive and can exert high phosphorus adsorption performance. The present invention relates to a phosphorus adsorbent comprising incinerator ash, cement, and lanthanum.

### TECHNICAL FIELD

The present invention relates to a phosphorus adsorbent.

### BACKGROUND ART

Effluent, such as industrial wastewater, domestic wastewater, or agricultural wastewater, contains nutrients, such as nitrogen and phosphorus, that cause eutrophication. It is known that when these nutrients flow into rivers, lakes and ponds, the sea, and the like, they cause the formation of red tides, water blooms, and the like in abundance. In urban areas, the effluent is treated in sewage treatment plants. The coverage of sewerage per population in Japan is 78.8% (in 2017 fiscal year), and, in sewerage undeveloped areas, such as suburban or depopulated areas, wastewater treatment tanks are provided as wastewater treatment systems. General wastewater treatment tanks do not have the function of removing nitrogen and phosphorus. As a result, the percentage achievement of the environmental quality standards for total nitrogen and total phosphorus (in 2015 fiscal year) is as low as 51.2% in lakes and ponds. Thus, wastewater treatment tanks installed in sewerage undeveloped areas are also required to perform an advanced treatment aiming to remove nitrogen and phosphorus.

Phosphorus needs to be recovered from wastewater, also from the viewpoint of the exhaustion of phosphorus resources. Conventionally known methods for removing phosphorus in water include a coagulative precipitation method that uses a metal salt or lime as a coagulant, a biological dephosphorization method (activated sludge method) that utilizes microbial metabolism, and an adsorption method. The coagulative precipitation method has high initial costs and high running cost performance, because it requires the addition of a large amount of expensive coagulant, and discharges a large amount of sludge that is difficult to dispose of. The biological dephosphorization method (activated sludge method) requires detailed control of dissolved oxygen concentration and control of sludge in the final sedimentation basin, and additionally requires treatment and disposal of sludge with high phosphorus content. Thus, in order to use these methods in a decentralized wastewater treatment apparatus, such as a wastewater treatment tank, it is required to increase facilities, and additionally control constant operation by experts.

The adsorption method has recently been proposed as a method that solves the above-described problems. The inventors of the present invention previously proposed a method for improving the water-quality environment, comprising adsorbing and oxidizing hydrogen sulfide in water, using coal ash granules obtained by granulating a mixture formed by adding 10 to 15 parts by weight of cement based on 100 parts by weight of coal ash, to reduce the hydrogen sulfide concentration (see Patent Literature 1). However, Patent Literature 1 merely discloses that the coal ash granules adsorb hydrogen sulfide in water.

Patent Literature 2 discloses an agent for removing phosphate ions contained in raw water, the agent being an iron ion-treated material that is ion-exchanged and/or loaded with an iron ion-containing aqueous solution. However, this phosphate ion-removing agent is inefficient, and is considered to be incapable of sufficiently removing phosphate ions. Furthermore, commercial phosphorus adsorbents are expensive, and thus, are difficult to use in a decentralized wastewater treatment apparatus, such as a wastewater treatment tank.

### CITATION LIST

### Patent Literature

Patent Literature 1: JP 2012-223733 A
Patent Literature 2: JP H10-192845 A

### SUMMARY OF INVENTION

### Technical Problem

It is an object of the present invention to provide a phosphorus adsorbent that is inexpensive and can exert high phosphorus adsorption performance.

### Solution to Problem

As a result of extensive research by the present inventors to develop a phosphorus adsorbent that is inexpensive and can exert high phosphorus adsorption performance, they have found that a phosphorus adsorbent with a high phosphorus adsorption amount and a high phosphorus adsorption rate can be obtained by granulating incinerator ash, cement, and lanthanum. The present invention has been completed based on this finding.

In summary, the present invention is as given below:

### Item 1.

A phosphorus adsorbent comprising incinerator ash, cement, and lanthanum.

### Item 2.

A phosphorus adsorbent obtained from incinerator ash, cement, and lanthanum.

### Item 3.

A phosphorus adsorbent produced by reacting incinerator ash, cement, and lanthanum.

### Item 4.

The phosphorus adsorbent according to any one of items 1 to 3, wherein the incinerator ash is coal ash.

### Item 5.

The phosphorus adsorbent according to any one of items 1 to 4, wherein the cement is included in an amount of 5 to 150 parts by mass based on 100 parts by mass of the incinerator ash.

### Item 6.

The phosphorus adsorbent according to any one of items 1 to 4, wherein the lanthanum is included in an amount of 0.1 to 15 parts by mass based on a total of 100 parts by mass of the incinerator ash and the cement.

### Item 7.

The phosphorus adsorbent according to any one of items 1 to 4, wherein the cement is included in an amount of 5 to 150 parts by mass based on 100 parts by mass of the incinerator ash, and the lanthanum is included in an amount of 0.1 to 15 parts by mass based on a total of 100 parts by mass of the incinerator ash and the cement.

### Item 8.

The phosphorus adsorbent according to any one of items 1 to 4, wherein the cement is included in an amount of 5 to 150 parts by mass based on 100 parts by mass of the incinerator ash, and the lanthanum is included in an amount of 0.5 to 4 parts by mass based on a total of 100 parts by mass of the incinerator ash and the cement.

### Item 9.

The phosphorus adsorbent according to any one of items 1 to 8, wherein the phosphorus adsorbent is porous.

### Item 10.

The phosphorus adsorbent according to any one of items 1 to 9, which is used to remove phosphorus contained in a decentralized wastewater treatment apparatus.

### Item 11.

The phosphorus adsorbent according to any one of items 1 to 9, which is used to remove phosphorus contained in effluent.

### Item 12.

A decentralized wastewater treatment apparatus comprising the phosphorus adsorbent according to any one of items 1 to 9.

### Item 13.

A wastewater treatment tank comprising the phosphorus adsorbent according to any one of items 1 to 9.

### Item 14.

A method for producing a phosphorus adsorbent, comprising obtaining a phosphorus adsorbent from incinerator ash, cement, and lanthanum.

### Item 15.

A method for producing a phosphorus adsorbent, comprising the step of granulating incinerator ash, cement, and lanthanum, using a solvent.

### Item 16.

The method for producing a phosphorus adsorbent according to item 14, further comprising the step of curing the obtained granules.

### Item 17.

The method for producing a phosphorus adsorbent according to any one of items 14 to 16, wherein the incinerator ash is coal ash.

### Item 18.

The method for producing a phosphorus adsorbent according to any one of items 14 to 17, wherein the cement is added in an amount of 5 to 150 parts by mass based on 100 parts by mass of the incinerator ash.

### Item 19.

The method for producing a phosphorus adsorbent according to any one of items 14 to 17, wherein the lanthanum is added in an amount of 0.1 to 15 parts by mass based on a total of 100 parts by mass of the incinerator ash and the cement.

Item 20.

The method for producing a phosphorus adsorbent according to any one of items 14 to 17, wherein the cement is added in an amount of 5 to 150 parts by mass based on 100 parts by mass of the incinerator ash, and the lanthanum is added in an amount of 0.1 to 15 parts by mass based on a total of 100 parts by mass of the incinerator ash and the cement.

### Item 21.

The method for producing a phosphorus adsorbent according to any one of items 14 to 17, wherein the cement is added in an amount of 5 to 150 parts by mass based on 100 parts by mass of the incinerator ash, and the lanthanum is added in an amount of 0.5 to 4 parts by mass based on a total of 100 parts by mass of the incinerator ash and the cement.

### Item 22.

The method for producing a phosphorus adsorbent according to any one of items 14 to 21, wherein after the granulating, the granules are cured and then calcined.

### Item 23.

The method for producing a phosphorus adsorbent according to item 22, wherein the calcination temperature is 600 to 1000° C.

### Item 24.

A phosphorus adsorption method comprising contacting the phosphorus adsorbent according to any one of items 1 to 9 with a liquid containing phosphorus.

### Item 25.

A phosphorus removal method comprising adsorbing and removing phosphorus in effluent by using the phosphorus adsorbent according to any one of items 1 to 9.

### Advantageous Effects of Invention

The phosphorus adsorbent of the present invention has a high phosphorus adsorption amount and a high phosphorus adsorption rate, and thus, can exert high phosphorus adsorption performance. Because the phosphorus adsorbent of the present invention is obtained using incinerator ash, cement, and lanthanum as raw materials, it is inexpensive, and can be used in a decentralized wastewater treatment apparatus, such as a wastewater treatment tank.

### BRIEF DESCRIPTION OF DRAWINGS

FIG. 1 is a graph showing the relationship between the phosphate adsorption amount, and the reaction time of the aqueous phosphate solution and samples 1 to 3 in Example 1.

FIG. 2 is a graph showing the relationship between the phosphate concentration, and the reaction time of the aqueous phosphate solution and samples 3 and 4.

FIG. 3 is a graph showing the relationship between the phosphate concentration, and the reaction time of the aqueous phosphate solution and samples 5 to 9 in Example 2.

FIG. 4 is a graph showing the relationship between the phosphate adsorption amount, and the reaction time of the aqueous phosphate solution and samples 5 to 9 in Example 2.

FIG. 5 is a graph showing the relationship between the phosphorus adsorption amount and samples 5 to 9 (calcination temperature: 600 to 1000° C.) in Example 2.

FIG. 6 shows, for samples 5 to 7 (calcination temperature: 600 to 800° C.) in

Example 2, and sample A (uncalcined) prepared as in Example 2 except that it was not calcined, after being subjected to the test as described in the below-described test examples, photographs of erlenmeyer flasks containing each solution, taken from above the erlenmeyer flask toward the bottom.

FIG. 7 is a graph showing the relationship between the phosphate concentration, and the reaction time of the aqueous phosphate solution and samples 10 to 14 in Example 3.

FIG. 8 is a graph showing the relationship between the solution pH, and the reaction time of the aqueous phosphate solution and samples 10 to 14 in Example 3.

FIG. 9 is a graph showing the relationship between the phosphate adsorption amount or the surface pH, and the lanthanum loading percentages of samples 15 to 19 in Example 4.

FIG. 10 is a graph showing the relationship between the strength and the lanthanum loading percentages of samples 15 to 19 in Example 4.

FIG. 11 is a graph showing the relationship between the BET specific surface area and the lanthanum loading percentages of samples 15 to 19 in Example 4.

### DESCRIPTION OF EMBODIMENTS

### 1. Phosphorus Adsorbent

A phosphorus adsorbent contains incinerator ash, cement, and lanthanum. The phosphorus adsorbent of the present invention has a high phosphorus adsorption amount and a high phosphorus adsorption rate, because mixing of the incinerator ash and the cement densifies the structure of the obtained mixture to improve the strength, and the lanthanum adsorbs phosphorus.

The incinerator ash is not limited as long as it contains silica (SiO₂) and alumina (Al₂O₃) among components. Examples of the incinerator ash include incinerator ash of waste, such as municipal refuse, wood chips, tire chips, paper sludge, sewage sludge, biomass, and like; and incinerator ash of coal, refuse derived fuel, refuse paper and plastic fuel, and the like. These types of incinerator ash can be used alone or as a mixture of two or more.

Of the above, incinerator ash of coal (coal ash) produced by electric power companies is preferably used because it contains less impurities, such as arsenic. The coal ash may be so-called fly ash, which is discharged from thermal power plants using coal as a fuel. Fly ash contains silica (SiO₂) and alumina (Al₂O₃) as main components, which account for 70 to 90% of the total, and contains oxides, such as Fe₂O₃, CaO, MgO, SO₃, Na₂O, K₂O, and MnO, as other components. Fly ash is useful as a raw material of the phosphorus adsorbent of the present invention, because it is produced in abundance during the combustion of coal, and is desired to be recycled.

Examples of types of the cement include, but are not limited to, general cements for concrete production, such as Portland cement and alumina cement. From the viewpoint of environmental sustainability, it is preferred to use cement that does not leach toxic components into waters, such as the ocean, and lakes and ponds. One example of cement with low leaching of toxic components is blast furnace cement (particularly blast furnace cement B class). It is preferred not to use Portland cement called ordinary cement, which leaches a large amount of toxic hexavalent chromium and the like.

A water-soluble lanthanum compound can be used as a raw material of the lanthanum. Examples of the water-soluble lanthanum compound include lanthanum chloride (LaCl₃), lanthanum nitrate (La(NO₃)₃), lanthanum sulfate (La₂(SO₄)₃), lanthanum acetate (La(CH₃CO₂)₃); or hydrates thereof. The lanthanum content in the phosphorus adsorbent can be measured by the X-ray fluorescence analysis method, for example.

As described above, the phosphorus adsorbent of the present invention, which contains incinerator ash, cement, and lanthanum, is not limited as long as it contains incinerator ash, cement, and lanthanum as raw materials; for example, the phosphorus adsorbent of the present invention may also include a “phosphorus adsorbent obtained from incinerator ash, cement, and lanthanum” as raw materials, a “phosphorus adsorbent produced by reacting incinerator ash, cement, and lanthanum” as raw materials, and the like. As used herein, the “phosphorus adsorbent obtained from incinerator ash, cement, and lanthanum” is defined using a product-by-process claim, because it is at present impossible or impractically difficult to identify all of the components that may be contained therein.

The amounts of the incinerator ash, cement, and lanthanum in the phosphorus adsorbent are as follows: the cement is included in an amount of preferably 5 to 150 parts by mass, more preferably 15 to 70 parts by mass, even more preferably 30 to 50 parts by mass, based on 100 parts by mass of the incinerator ash, and the lanthanum is included in an amount of preferably 0.1 to 15 parts by mass, more preferably 0.2 to 10 parts by mass, even more preferably 0.5 to 5 parts by mass, based on a total of 100 parts by mass of the incinerator ash and the cement. When the amount of each component falls in the above-defined range, it is possible to obtain granules that can exert higher phosphorus adsorption performance.

From the viewpoint of high adsorption performance, strength of the phosphorus adsorbent, and the like, the amount of the lanthanum is preferably 0.5 to 4 parts by mass, more preferably 0.7 to 2 parts by mass, and particularly preferably 0.9 to 1.1 parts by mass, based on a total of 100 parts by mass of the incinerator ash and the cement.

The phosphorus adsorbent is preferably granules containing incinerator ash, cement, and lanthanum. Because the incinerator ash contains silica (SiO₂) and alumina (Al₂O₃), upon mixing with the cement, it reacts with calcium hydroxide produced during the hydration of the cement (pozzolanic reaction) to produce calcium silicate hydrate, calcium aluminate hydrate, and the like. This densifies the structure of the obtained mixture to improve the strength. Moreover, the lanthanum present on the surface of and inside the granules acts to adsorb phosphorus. Thus, the phosphorus adsorbent of the present invention is preferably porous.

Phosphorus to be adsorbed may be any substance containing phosphorus element, and examples include ions containing phosphorus element (phosphate ions). Phosphate ions include orthophosphate ion (PO₄³⁻), dihydrogen phosphate ion (H₂PO₄⁻), and hydrogen phosphate ion (HPO₄²⁻), which are produced in the dissociation stage of orthophosphoric acid (H₃PO₄), as well as phosphite ion and polyphosphate ion.

The BET specific surface area of the phosphorus adsorbent is preferably 1 m²/g or more, more preferably 10 m²/g or more, and even more preferably 20 m²/g or more. When the BET specific surface area of the phosphorus adsorbent is 1 m²/g or more, the phosphorus adsorbent can exert high phosphorus adsorption performance. The upper limit of the BET specific surface area may be about 100 m²/g, although not limited thereto.

The phosphorus adsorbent is preferably in the form of particles. The particle diameter is not limited, and may be set appropriately according to the purpose, conditions of use (phosphorus adsorption conditions), and the like. For example, the average particle diameter may be about 1 to 30 mm. For use in a wastewater treatment tank, the average particle diameter is preferably 5 mm or more, more preferably 5 to 20 mm, and even more preferably 5 to 10 mm, from the viewpoint of handling. The particle diameter can be adjusted in these ranges by using a known method, for example, classification and grinding. The particle shape of the phosphorus adsorbent is also not limited, and may be any of spherical, flaky, amorphous, and the like. In particular, the particle shape is preferably spherical, from the viewpoint of ease of packing into a fixed bed (such as a column), ease of circulation of liquid, and the like.

The phosphorus adsorption amount of the phosphorus adsorbent of the present invention is, for example, 5 mg/g or more, preferably about 10 to 24 mg/g, although it may vary depending on the experimental conditions. The phosphorus adsorption rate of the phosphorus adsorbent of the present invention is about 0.8 to 1 mg/L/h (see the examples). Because of this high phosphorus adsorption performance (high phosphorus adsorption amount and high phosphorus adsorption rate), the phosphorus adsorbent of the present invention can be used to remove phosphorus in water. In particular, because the phosphorus adsorbent of the present invention is inexpensive, and has high phosphorus adsorption performance, it can be used in a decentralized wastewater treatment apparatus, particularly a wastewater treatment tank. When the phosphorus adsorbent of the present invention is used in a wastewater treatment tank, it is capable of adsorbing and removing phosphorus sustainedly without maintenance, over a period of about one year, as will be described in the examples below.

### 2. Method for Producing the Phosphorus Adsorbent

The phosphorus adsorbent of the present invention is obtained by granulating incinerator ash, cement, and lanthanum, using a solvent. The production method is not limited as long as it produces granules containing incinerator ash, cement, and lanthanum. The solvent used for granulation is not limited as long as granules can be formed. The solvent preferably contains water, and may be, for example, water (such as tap water, distilled water, or ion exchange water), seawater, brackish water, ground water, river water, aqueous sodium chloride solution, or aqueous lithium nitrite solution. The amount of the solvent to be used may be adjusted appropriately to allow the formation of granules, depending on the amount of each raw material added.

Examples of the production method include (1) a method in which incinerator ash, cement, lanthanum, and a solvent (such as water) are simultaneously mixed and granulated; (2) a method in which incinerator ash, cement, and a solvent (such as water) are mixed and granulated, and lanthanum is loaded on the resulting granules; (3) a method in which incinerator ash and lanthanum are premixed, and the mixture is mixed with cement and a solvent (such as water) and granulated; and (4) a method in which cement and lanthanum are premixed, and the mixture is mixed with incinerator ash and a solvent (such as water) and granulated. Of these production methods, preferred is the method (2) in which incinerator ash, cement, and a solvent (such as water) are mixed and granulated, and lanthanum is loaded on the obtained granules, because of the ease of controlling the amount of lanthanum added.

Examples of methods of loading lanthanum on the granules containing incinerator ash and cement in the method (2) include a method in which the granules are immersed in an aqueous lanthanum solution in which a water-soluble lanthanum compound is dissolved in water, and then dried; and a method in which the aqueous lanthanum solution is sprayed onto the granules. Examples of the water-soluble lanthanum compound include lanthanum chloride (LaCl₃), lanthanum nitrate (La(NO₃)₃), lanthanum sulfate (La₂(SO₄)₃), lanthanum acetate (La(CH₃CO₂)₃), and hydrates thereof. The concentration of the aqueous lanthanum solution to be used may be adjusted appropriately so that the phosphorus content in the final product phosphorus adsorbent falls in the below-defined range.

The cement may be added in an amount of preferably 5 to 150 parts by mass, more preferably 15 to 70 parts by mass, even more preferably 30 to 50 parts by mass, based on 100 parts by mass of the incinerator ash, and the lanthanum may be added in an amount of preferably 0.1 to 15 parts by mass, more preferably 0.2 to 10 parts by mass, even more preferably 0.5 to 5 parts by mass, particularly preferably 0.9 to 1.1 parts by mass, based on a total of 100 parts by mass of the incinerator ash and the cement.

In the case of the method (2), incinerator ash and cement may be mixed in a mass ratio of preferably 95-40:5-60, more preferably 60-80:40-20, even more preferably 65-75:35-25; a solvent (such as water) may be added in an amount of 20 to 30% by mass of the total amount of the incinerator ash and the cement and mixed, and granulated; and lanthanum may be loaded in an amount of preferably 0.1 to 15 parts by mass, more preferably 0.2 to 10 parts by mass, even more preferably 0.5 to 5 parts by mass, particularly preferably 0.9 to 1.1 parts by mass, based on 100 parts by mass of the resulting granules.

The resulting granules are preferably further cured and then calcined. The granules are made porous by the curing, and then calcined, which can strengthen the bond between the incinerator ash or the cement and the lanthanum, and improve the phosphorus adsorption performance of the lanthanum. The curing conditions may be adjusted appropriately according to the temperature, humidity, and the like. The curing includes, for example, allowing to dry naturally for about several days to several weeks. From the viewpoint of the phosphorus saturated adsorption amount and the strength of the calcined granules, the calcination temperature is preferably 500 to 1000° C., more preferably 600 to 1000° C., even more preferably 600 to 800° C., and particularly preferably 800° C.

The calcination atmosphere is not limited, and may, for example, be any of an oxidizing atmosphere (in air), a reducing atmosphere, an inert gas atmosphere, and the like. The calcination time may also be adjusted appropriately according to the calcination temperature and the like.

The obtained sintered body is in the form of particles, and can be used as is for phosphorus adsorption purposes. Alternatively, the sintered body may be optionally subjected to a treatment such as grinding and classification, and then used for phosphorus adsorption purposes.

### 3. Phosphorus Adsorption Method

The present invention also includes a phosphorus adsorption method comprising the step of contacting the phosphorus adsorbent with a liquid containing phosphorus. Phosphorus contained in the liquid may be any substance containing phosphorus element, and examples include ions containing phosphorus element (phosphate ions).

The adsorption method of the present invention is not limited in the processes of contacting the adsorbent with the liquid containing phosphorus, as long as this can be achieved. For example, the adsorption method may use any of a method in which the adsorbent is contacted with the liquid in a batchwise mode; a method in which the adsorbent is contacted with the liquid while the liquid is being continuously supplied and flowed in a continuous mode; and the like. Alternatively, a fixed bed-type process or a moving bed-type process may be used.

Examples of the liquid containing phosphorus (particularly a liquid containing water as the medium) include, but are not limited to, effluent, such as industrial wastewater, domestic wastewater, and agricultural wastewater; and lake and pond water, seawater, river water, and the like. The phosphate concentration in these liquids is also not limited, and may be pre-adjusted to about 0.1 to 200 mg-P/L, for example. The unit of concentration (mg-P/L) refers to the concentration of phosphate-phosphorus, and indicates the mass concentration of phosphorus present as phosphate ions.

The temperature during the contacting of the adsorbent with the liquid containing phosphorus (i.e., the temperature of the liquid) is also not limited as long as the liquid state is maintained.

The amount of the ion adsorbent of the present invention used relative to the liquid containing phosphorus is not limited, and may be determined appropriately according to the phosphorus concentration and the like.

As described above, the phosphorus adsorbent of the present invention can be used in, for example, a centralized wastewater (effluent) treatment facility, a decentralized wastewater treatment apparatus, and the like. Thus, the present invention also includes a phosphorus removal method comprising the step of adsorbing and removing phosphorus in a centralized wastewater (effluent) treatment facility or phosphorus in a decentralized wastewater treatment apparatus, by using the phosphorus adsorbent. Examples of the centralized wastewater (effluent) treatment facility include a sewage treatment plant, an agricultural community wastewater treatment facility, and a night soil treatment plant. The decentralized wastewater treatment (also referred to as the on-site decentralized wastewater treatment) refers to treatment performed at the site where the wastewater is produced. The decentralized wastewater treatment apparatus refers to an apparatus used in the decentralized wastewater treatment, and examples include a wastewater treatment tank, a septic tank, a small-scale industrial wastewater treatment apparatus, and an aquatic plant wastewater treatment apparatus. The phosphorus adsorbent of the present invention is inexpensive, and requires less frequent maintenance, and thus, is suitable for use in a decentralized wastewater treatment apparatus.

The adsorbent after being used in the adsorption method of the present invention may be subjected to a physical or chemical treatment to desorb the adsorbed phosphorus. Examples of the physical treatment include ultrasonic treatment, heating, voltage application, and pneumatic or hydraulic pressure control. Examples of the chemical treatment include pH control with an acid or alkali. The desorbed phosphorus component can be separated from the phosphorus adsorbent and recovered. The phosphorus adsorbent after separation of the phosphorus component can also be recycled. Alternatively, the adsorbent with phosphorus adsorbed thereon can be used as is as a fertilizer.

### EXAMPLES

The present invention will be described in more detail with reference to examples, although the technical scope of the invention is not limited to these examples.

### Example 1

35 g of coal ash was placed in a beaker, 175 mL of a 1.0 mol/L aqueous solution of LaCl₃·7H₂O was added thereto, and the mixture was stirred at 1000 rpm for 24 hours, and then filtered through a glass fiber filter paper, grade GF/F (diameter: 47 mm, particle retention capacity: 0.7 μm), and dried at 45° C. for 24 hours. The obtained lanthanum-loaded coal ash was mixed with blast furnace cement in a mass ratio of 70:30, water was added in an amount equivalent to 20% of the mass of the obtained mixture, the mixture was granulated using a granulator at a pan granulator angle of 30 degrees and speed of 35 rpm, and the obtained granules were cured for 4 weeks to be hardened (porous). Water was sprayed onto the granules every day for the first 7 days. Of the obtained granules, granules with a diameter of 1 mm or more and less than 3.35 mm were used as sample 1, and granules with a diameter of 3.35 mm and more and 4.75 mm or less were used as sample 2. Measurement of the lanthanum content using an X-ray fluorescence analyzer (Rigaku Corporation; Supermini 200) showed that samples 1 and 2 contained lanthanum in an amount equivalent to 3.9% of the total mass of coal ash and blast furnace cement.

As sample 3, granules with a diameter of 1 mm or more and 5 mm or less were used which were prepared by granulating and curing in the same procedure as described above, except that the aqueous solution of LaCl₃·7H₂O was not used.

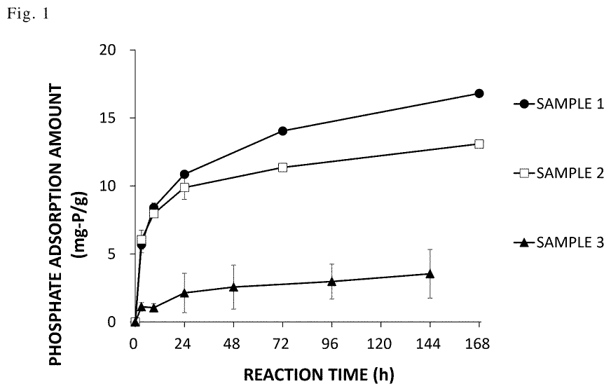

For samples 1 to 3, a batchwise phosphate adsorption test was performed as follows. An aqueous phosphate solution with a phosphate concentration of 100 mg-P/L was prepared using sodium dihydrogen phosphate (NaH₂PO₄) as a phosphate component. To 100 mL of the aqueous phosphate solution, 0.5 g of each of the samples was added, and the mixture was agitated at 100 rpm in a constant temperature oven while being maintained at 25° C. Before the addition of the sample to the aqueous phosphate solution (0 h), or 3 h, 9 h, 24 h, 72 h, or 168 h after the addition of the sample, the supernatant was sampled with a 1.5-mL syringe, and filtered through a syringe filter with a nominal pore diameter of 0.45 gm. The phosphate ion concentration in the filtrate was measured by the molybdenum blue method, using a spectrophotometer (UV-2600; Shimadzu Corporation) at the absorbance of 880 nm, and the phosphate adsorption amount was calculated according to the equation shown below. The results are shown in Table 1 and FIG. 1.
<Phosphate adsorption amount>
q=Sᵣₑₘ(C_{con}−Cₛₐₘ)/(1000·a)
where
q: phosphate adsorption amount (mg-P/g)
Sᵣₑₘ: residual amount (mL) of solution
C_{con}: control concentration (mg-P/L)
Cₛₐₘ: sample concentration (mg-P/L)
a: dosage of adsorbent (g)

The unit of adsorption amount (mg-P/g) refers to the amount of phosphate-phosphorus, and indicates the mass of phosphorus present as phosphate ions.

TABLE 1

| | Reaction Time (h) | 0 | 3 | 9 | 24 | 48 | 72 | 96 | 144 | 168 |
|---|---|---|---|---|---|---|---|---|---|---|
| Phosphate | Sample 1 | 0.0 | 5.7 | 8.4 | 10.9 | | 14.0 | | | 16.8 |
| Adsorption | Sample 2 | 0.0 | 6.0 | 8.0 | 9.9 | | 11.4 | | | 13.2 |
| Amount | Sample 3 | 0.0 | 1.1 | 1.0 | 2.1 | 2.6 | | 3.0 | 3.5 | |
| (mg-P/g) | | | | | | | | | | |

It is seen from Table 1 and FIG. 1 that samples 1 and 2 containing coal ash, cement, and lanthanum exert phosphate adsorption amounts higher than that of sample 3 without containing lanthanum. In particular, the adsorption amount after 168 h (saturated adsorption amount) is 16.8 mg-P/g for sample 1 and 13.2 mg-P/g for sample 2, which indicates that when sample 1 or 2 is used in a wastewater treatment tank, maintenance is not required for about one year.

The pH of each sampled solution was measured using a pH meter (Horiba Compact pH Meter LAQUAtwin B-711; Horiba, Ltd.). As a result, the solutions pH of samples 1 and 2 had a pH in the range of 7 to 8.2 in all cases, and thus, were found to meet the wastewater standard values (pH 5.8 to 8.6). In contrast, the solution of sample 3 had a pH above 8.6 in some cases.

Coal ash and blast furnace cement were mixed in a mass ratio of 70:30, water was added in an amount equivalent to 20% of the mass of the obtained mixture, and the mixture was granulated in a granulator at a pan granulator angle of 30 degrees and speed of 35 rpm to prepare granules with a diameter of about 1 to 5 mm. The granules were cured for 4 weeks to be hardened (porous). Water was sprayed onto the granules every day for the first 7 days. 4.2 g of the granules were immersed in a 0.5 mol/L aqueous solution of LaCl₃·7H₂O for 24 hours and then dried in a dryer at 45° C. for 24 hours. The obtained granules were used as sample 4. Measurement of the lanthanum content using the above-mentioned X-ray fluorescence analyzer showed that sample 4 contained lanthanum in an amount equivalent to 10.7% of the total mass of coal ash and blast furnace cement.

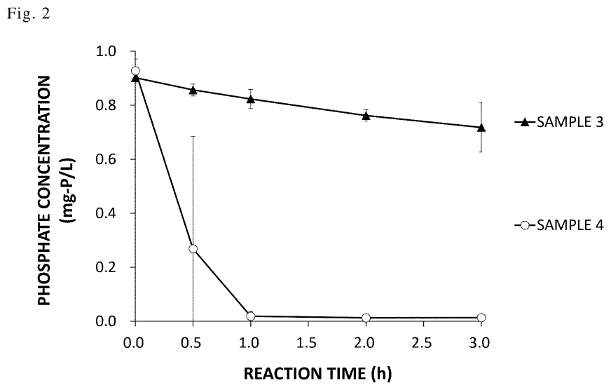

For sample 4 and the above-mentioned sample 3, sampling was performed as described above, before the addition of the sample to a 1 mg-P/L aqueous phosphate solution (0 h), or 0.5 h, 1 h, 2 h, 3 h, or 168 h after the addition of the sample, and the phosphate concentration in the solution was measured by the molybdenum blue method. The results are shown in Table 2 and FIG. 2.

TABLE 2

| | Reaction Time (h) | 0.0 | 0.5 | 1.0 | 2.0 | 3.0 |
|---|---|---|---|---|---|---|
| Phosphate | Sample 3 | 0.90 | 0.86 | 0.82 | 0.76 | 0.72 |
| Concentration | Sample 4 | 0.93 | 0.27 | 0.02 | 0.01 | 0.01 |
| (mg-P/L) | | | | | | |

It is seen from Table 2 and FIG. 2 that sample 4 containing lanthanum exerted a rate of phosphate adsorption higher than that of sample 3 without containing lanthanum.

### Example 2

Coal ash and blast furnace cement were mixed in a mass ratio of 70:30, water was added in an amount equivalent to 20% of the mass of the obtained mixture, and the mixture was granulated in a granulator at 30° C. and 35 rpm to prepare granules with a diameter of about 1 to 5 mm. The obtained granules were cured for 4 weeks to be hardened (porous). Water was sprayed onto the granules every day for the first 7 days.

40 g of the granules were placed in an evaporating dish, and an aqueous solution of 4.4561 g of LaCl_{3.7}H₂O in 50 mL of ultrapure water was added thereto and impregnated at room temperature (about 25° C.) for 1 day. Then, the evaporating dish was placed in an oven and dried at 105° C. for 8 hours. The lanthanum content was measured twice using the above-mentioned X-ray fluorescence analyzer. As a result, the resulting phosphorus adsorbent contained lanthanum in an amount equivalent to 3.42% (first measurement) or 3.95% (second measurement) of the total mass of coal ash and blast furnace cement.

The obtained phosphorus adsorbent was calcined at 600° C. (sample 5), 700° C. (sample 6), 800° C. (sample 7), 900° C. (sample 8), and 1000° C. (sample 9). The calcination was performed under the following conditions: 125° C. 3 hours after the start, 2 hours thereafter the above-mentioned calcination temperature, the calcination temperature maintained for 2 hours, and then cooling to room temperature.

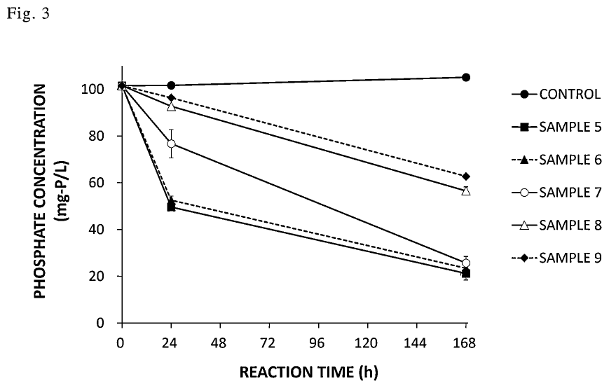

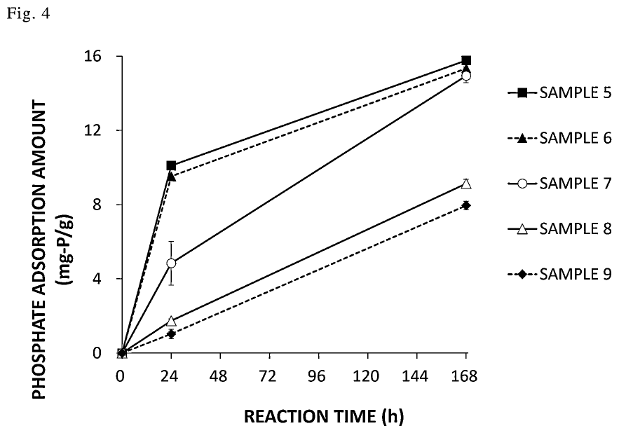

For samples 5 to 9, a batchwise phosphate adsorption test was performed as in Example 1. 0.25 g of each of the samples was added to 50 mL of an aqueous phosphate solution with a phosphate concentration of 100 mg-P/L, and the mixture was agitated while being maintained at 25° C. Sampling was performed before the addition of the sample to the aqueous phosphate solution (0 h), or 24 h or 168 h after the addition of the sample, and the phosphate concentration in the solution was measured and the adsorption amount was calculated, as in Example 1. For a sample prepared without adding a phosphorus adsorbent (control), the phosphate concentration was similarly determined. The measured phosphate concentrations are shown in Table 3 and FIG. 3, and the measured phosphate adsorption amounts are shown in Table 4 and FIG. 4.

TABLE 3

| | Reaction Time (h) | 0 | 24 | 168 |
|---|---|---|---|---|
| Phosphate | Control | 101.5 | 101.6 | 105.1 |
| Concentration | Sample 5 | 101.5 | 49.6 | 21.2 |
| (mg-P/L) | Sample 6 | 101.5 | 52.5 | 23.4 |
| | Sample 7 | 101.5 | 76.7 | 25.7 |
| | Sample 8 | 101.5 | 92.7 | 56.5 |
| | Sample 9 | 101.5 | 96.3 | 62.7 |

TABLE 4

| | Reaction Time (h) | 0 | 24 | 168 |
|---|---|---|---|---|
| Phosphate | Sample 5 | 0.0 | 10.1 | 15.8 |
| Adsorption | Sample 6 | 0.0 | 9.5 | 15.3 |
| Amount | Sample 7 | 0.0 | 4.8 | 15.0 |
| (mg-P/g) | Sample 8 | 0.0 | 1.7 | 9.1 |
| | Sample 9 | 0.0 | 1.0 | 8.0 |

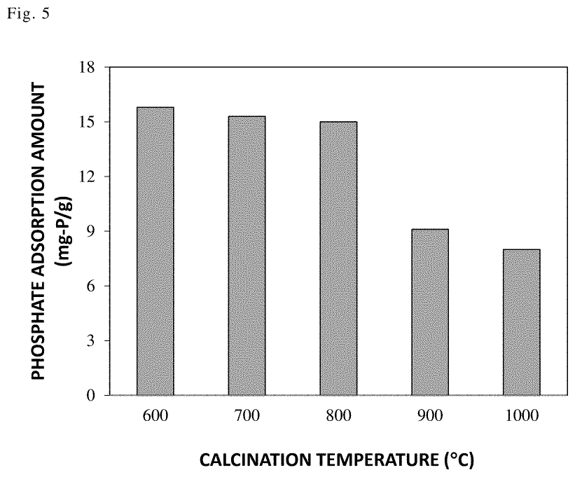

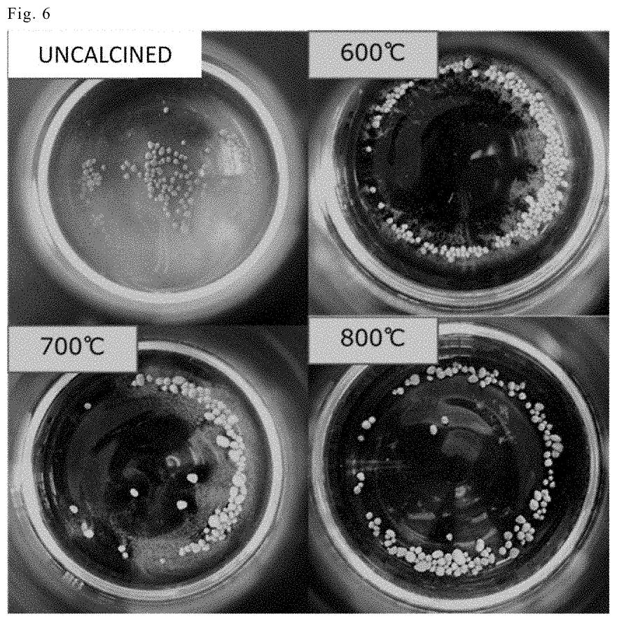

The appearance of the aqueous phosphate solution after 168 h was observed by the naked eye. The results are shown in Table 5 and FIG. 5, along with the phosphate adsorption amount after 168 h. For samples 5 to 9 and a sample (uncalcined) prepared as in Example 2 except that it was not calcined, after being subjected to the above-described test, photographs of erlenmeyer flasks containing each solution, taken from above the erlenmeyer flask toward the bottom, are shown in FIG. 6.

TABLE 5

| | Phosphate | |
|---|---|---|
| | Adsorption | |
| | Amount | |
| Sample (Calcination Temperature) | (mg-P/g) | Appearance |
| Sample 5 (600° C.) | 15.8 | Turbid |
| Sample 6 (700° C.) | 15.3 | Turbid |
| Sample 7 (800° C.) | 15.0 | No Precipitation |
| Sample 8 (900° C.) | 9.1 | No Precipitation |
| Sample 9 (1000° C.) | 8.0 | No precipitation |

It is seen from Tables 3 and 4, and FIGS. 3, 4, and 5 that the lower the calcination temperature, the higher the phosphate adsorption rate, and the greater the saturated adsorption amount, as demonstrated by samples 5 to 7. It is seen from Table 5 and FIG. 6 that when the calcination temperature was 800° C. or more, lanthanum phosphate forms no precipitation. The precipitation refers to the turbidity of lanthanum phosphate settling to the bottom of the container, and “No Precipitation” means the same as “not turbid”.

Water treated with the phosphorus adsorbent is preferably free from precipitation (turbidity). The turbidity observed in the uncalcined sample, and samples 5 and 6, as shown in FIG. 6, is believed to be due to partial separation of the adsorbent. This turbidity can be removed using a known removal or purification method, for example, by filtering out the turbidity, or by collecting the supernatant after allowed to stand, and then using it. As a result, for samples 5 and 6 with high phosphate adsorption amounts as well, if the turbidity is removed using the above-described method, treated water without turbidity can be obtained and then used.

### Example 3

Coal ash and blast furnace cement were mixed in a mass ratio of 70:30, water was added in an amount equivalent to 20% of the mass of the obtained mixture, and the mixture was granulated in a granulator at 30° C. and 35 rpm to prepare granules with a diameter of about 1 to 5 mm. The obtained granules were cured for 4 weeks to be hardened (porous). Water was sprayed onto the granules every day for the first 7 days. 5 g of the granules (diameter: 3.35 mm or more and less than 4.75 mm) were immersed in 10 mL of a LaCl_{3.7}H₂O solution (0.67 g/10 mL) at room temperature (about 25° C.) for 24 hours. Then, the LaCl_{3.7}H₂O solution was dried up in an oven at 105° C. and used as sample 10. Measurement of the lanthanum content using the above-mentioned X-ray fluorescence analyzer showed that sample 10 contained lanthanum in an amount equivalent to 4.2% of the total mass of coal ash and blast furnace cement. Moreover, sample 10 was calcined at 600° C. for 3 hours (diameter: 3.35 mm or more and less than 4.75 mm) and used as sample 11.

30 mL of a 0.25 mol/L aqueous solution of LaCl_{3.7}H₂O was sprayed onto 50 g of coal ash, the obtained lanthanum-loaded coal ash was mixed with blast furnace cement in a mass ratio of 70:30, water was added in an amount equivalent to 20% of the mass of the obtained mixture, the mixture was granulated using a granulator at 30° C. and 35 rpm, and the obtained granules were cured for 4 weeks to be hardened (porous). Water was sprayed onto the granules every day for the first 7 days. The obtained granules were calcined at 600° C. for 3 hours (diameter: 1 mm or more and less than 3.35 mm) and used as sample 12.

### COMPARATIVE EXAMPLE

Two commercial phosphorus adsorbents were used as comparative examples. A Kamihata phosphate adsorption filter material, Phosphate Remover (product name), from Kamihata Fish Industries Ltd., was used as sample 13, and Eheim Phosphate Remover (product name) from Eheim was used as sample 14. The particles of samples 13 and 14 both had a diameter of 3.35 mm or more and less than 4.75 mm.

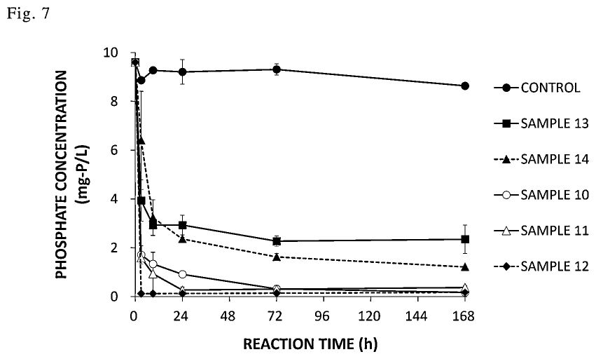

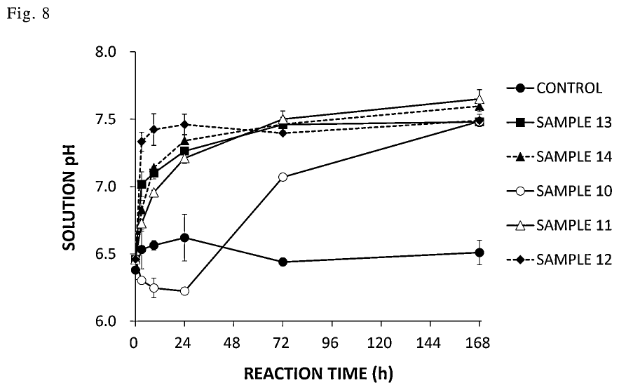

For samples 10 to 14, a batchwise phosphate adsorption test was performed as in Example 1.0.5 g of each of the samples was added to 100 mL of an aqueous phosphate solution with a phosphate concentration of 10 mg-P/L, and the mixture was agitated at 100 rpm while being maintained at 25° C. Sampling was performed before the addition of the sample to the aqueous phosphate solution (0 h), or 3 h, 9 h, 24 h, 72 h, or 168 h after the addition of the sample, and the phosphate concentration in the solution and the pH of the solution were measured as in Example 1. The same pH meter as above was used in the pH measurement. For a sample prepared without adding a phosphorus adsorbent (control), the phosphate concentration and the pH were similarly measured. The results are shown in Table 6, FIG. 7, Table 7, and FIG. 8.

TABLE 6

| | Reaction Time (h) | 0 | 3 | 9 | 24 | 72 | 168 |
|---|---|---|---|---|---|---|---|
| Phosphate | Control | 9.6 | 8.9 | 9.3 | 9.2 | 9.3 | 8.6 |
| Concentration | Sample 13 | 9.6 | 3.9 | 2.9 | 2.9 | 2.3 | 2.3 |
| (mg-P/L) | Sample 14 | 9.6 | 6.4 | 3.2 | 2.4 | 1.6 | 1.2 |
| | Sample 10 | 9.6 | 1.7 | 1.3 | 0.9 | 0.3 | 0.2 |
| | Sample 11 | 9.6 | 1.6 | 0.9 | 0.3 | 0.3 | 0.4 |
| | Sample 12 | 9.6 | 0.1 | 0.1 | 0.1 | 0.1 | 0.2 |

TABLE 7

| | Reaction Time (h) | 0 | 3 | 9 | 24 | 72 | 168 |
|---|---|---|---|---|---|---|---|
| Solution | Control | 6.4 | 6.5 | 6.6 | 6.6 | 6.4 | 6.5 |
| pH | Sample 13 | 6.5 | 7.0 | 7.1 | 7.3 | 7.5 | 7.5 |
| | Sample 14 | 6.5 | 6.8 | 7.1 | 7.3 | 7.5 | 7.6 |
| | Sample 10 | 6.5 | 6.3 | 6.2 | 6.2 | 7.1 | 7.5 |
| | Sample 11 | 6.5 | 6.7 | 7.0 | 7.2 | 7.5 | 7.7 |
| | Sample 12 | 6.5 | 7.3 | 7.4 | 7.5 | 7.4 | 7.5 |

It is seen from Table 6 and FIG. 7 that samples 10 to 12 (phosphorus adsorbents of the present invention) exhibit rate of phosphate adsorption higher than those of samples 13 and 14 (commercial phosphorus adsorbents). It is also shown from Table 7 and FIG. 8 that the solutions of samples 10 to 12 (phosphorus adsorbents of the present invention) have a pH in the range of 6 to 8 in all cases, and thus, meet the wastewater standard values (pH 5.8 to 8.6) without additional pH adjustment.

### Example 4

Coal ash and blast furnace cement were mixed in a mass ratio of 70:30, water was added in an amount equivalent to 20% of the mass of the obtained mixture, and the mixture was granulated in a granulator at a pan granulator angle of 30 degrees and speed of 35 rpm to prepare granules with a diameter of about 1 to 5 mm. The obtained granules were cured for 4 weeks to be hardened (porous). Water was sprayed onto the granules every day for the first 7 days.

Aqueous solutions of LaCl₃·7H₂O in 50 mL of ultrapure water were prepared so that the theoretical loading percentage of lanthanum (La) based on the mass of the granules was 0.1%, 0.5%, 1%, 2%, or 4%. Specifically, to prepare granules with a La loading percentage of 0.1%, 0.107 g of LaCl_{3.7}H₂O was dissolved in 50 mL of ultrapure water (aqueous solution 15). To prepare granules with a La loading percentage of 0.5%, 0.535 g of LaCl_{3.7}H₂O was dissolved in 50 mL of ultrapure water (aqueous solution 16). To prepare granules with a La loading percentage of 1%, 1.07 g of LaCl_{3.7}H₂O was dissolved in 50 mL of ultrapure water (aqueous solution 17). To prepare granules with a La loading percentage of 2%, 2.14 g of LaCl_{3.7}H₂O was dissolved in 50 mL of ultrapure water (aqueous solution 18). To prepare granules with a La loading percentage of 4%, 4.28 g of LaCl_{3.7}H₂O was dissolved in 50 mL of ultrapure water (aqueous solution 19).

40 g of the obtained granules were placed in an evaporating dish, and 50 mL of each of the aqueous solutions 15 to 19 was added thereto and impregnated at room temperature (about 25° C.) for 1 day. Then, the evaporating dish was placed in an oven and dried at 105° C. for 3 hours to load lanthanum on the granules. The lanthanum-loaded granules were further calcined in an electric furnace at 800° C. for 2 hours, and allowed to cool naturally in the furnace, to obtain samples 15 to 19.

Lanthanum contents in samples 15 to 19 were measured using the above-mentioned X-ray fluorescence analyzer to measure the lanthanum loading percentages. As a result, the lanthanum loading percentage of each sample was 0.08% (sample 15), 0.50% (sample 16), 0.91% (sample 17), 2.19% (sample 18), or 3.95% (sample 19). Thus, the prepared granules had a lanthanum loading percentage close to the theoretical value.

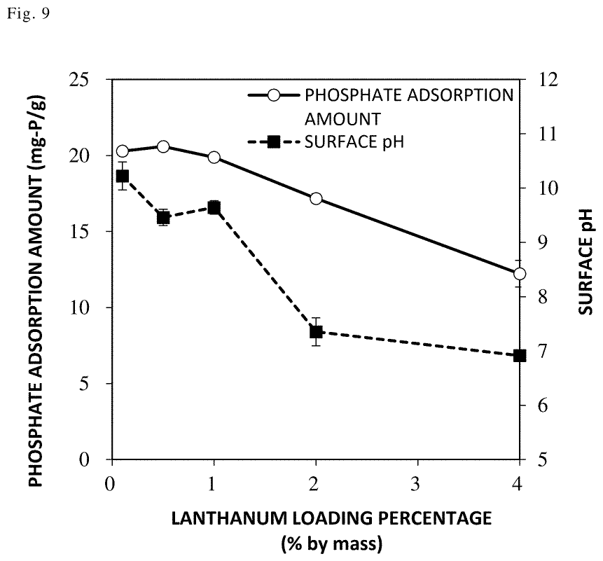

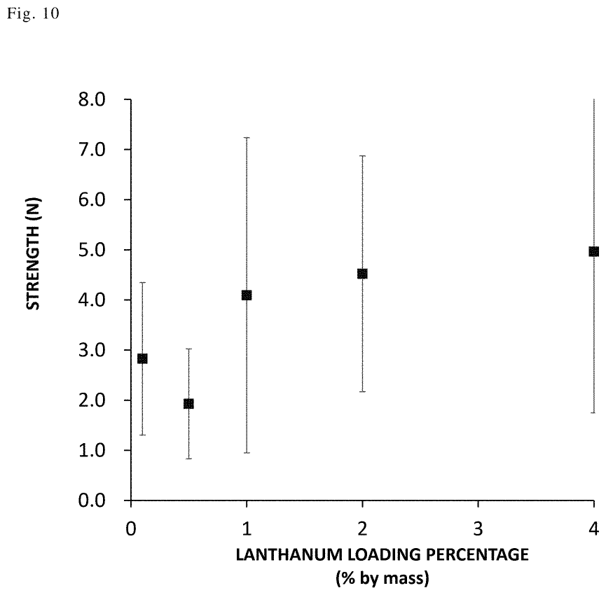

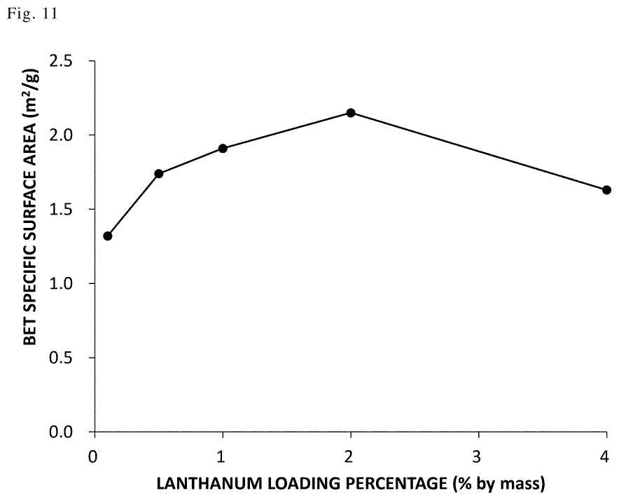

For each of the obtained samples 15 to 19, the phosphate adsorption amount was measured 168 hours after the addition of the sample, using the same measurement method as in Example 1. The pH of the surface of the sample, the strength of the sample, and the BET specific surface area were measured using the methods shown below. The measured pHs are shown in Table 8 and FIG. 9, the measured strengths are shown in Table 9 and FIG. 10, and the measured BET specific surface areas are shown in Table 10 and FIG. 11.

### pH

The pH of the surface of each sample was measured using the same pH meter (Horiba Compact pH Meter LAQUAtwin B-711; Horiba, Ltd.).

### Strength

For each sample, a point load was measured with a force gauge (Digital Force Gauge S-3; Imada).

### BET Specific Surface Area

For each sample, the BET specific surface area was measured with nitrogen gas, using an automated specific surface area analyzer (Gemini VII 2390; Shimadzu Corporation).

TABLE 8

| | Sample | Sample | Sample | Sample | Sample |
|---|---|---|---|---|---|
| | 15 | 16 | 17 | 18 | 19 |
| Lanthanum Loading | 0.1 | 0.5 | 1.0 | 2.0 | 4.0 |
| percentage (%) | | | | | |
| Surface pH | 10.2 | 9.5 | 9.6 | 7.4 | 6.9 |
| Phosphate Adsorption | 20.3 | 20.6 | 19.9 | 17.2 | 12.2 |
| Amount | | | | | |
| (mg-P/g) | | | | | |

TABLE 9

| | Sample | Sample | Sample | Sample | Sample |
|---|---|---|---|---|---|
| | 15 | 16 | 17 | 18 | 19 |
| Lanthanum Loading | 0.1 | 0.5 | 1.0 | 2.0 | 4.0 |
| percentage (%) | | | | | |
| Strength (N) | 2.83 | 1.93 | 4.09 | 4.52 | 4.96 |

TABLE 10

| | Sample | Sample | Sample | Sample | Sample |
|---|---|---|---|---|---|
| | 15 | 16 | 17 | 18 | 19 |
| Lanthanum Loading | 0.1 | 0.5 | 1.0 | 2.0 | 4.0 |
| percentage (%) | | | | | |
| BET Specific | 1.32 | 1.74 | 1.91 | 2.15 | 1.63 |
| Surface Area | | | | | |
| (m²/g) | | | | | |

It is seen from Table 8 and FIG. 9 that phosphorus adsorbents with lanthanum loading percentages of 0.1 to 1% (samples 15 to 17) exhibit higher phosphate adsorption amounts. It is also seen that the surface pH value decreases as the lanthanum loading increases. It is seen from Table 9 and FIG. 10 that phosphorus adsorbents with lanthanum loading percentages of 1% or more (samples 17 to 19) have sufficient strength. Moreover, it is seen from Table 10 and FIG. 11 that phosphorus adsorbents with lanthanum loading percentages of 0.1 to 4% (samples 15 to 19) all have BET specific surface areas of 1 m²/g or more, and can exert high phosphate adsorption performance.

### INDUSTRIAL APPLICABILITY

The phosphorus adsorbent of the present invention has a high phosphorus adsorption amount and a high phosphorus adsorption rate, and thus, is useful for the purpose of removing phosphorus in water. In particular, the phosphorus adsorbent of the present invention is inexpensive, and can exert phosphorus adsorption performance over a long period, and thus, can be used in a decentralized wastewater treatment apparatus, such as a wastewater treatment tank.

The invention claimed is:

1. A phosphorus adsorbent comprising incinerator ash, cement, and lanthanum.

2. The phosphorus adsorbent according to claim 1, wherein the incinerator ash is coal ash.

3. The phosphorus adsorbent according to claim 1, wherein the cement is included in an amount of 5 to 150 parts by mass based on 100 parts by mass of the incinerator ash, and the lanthanum is included in an amount of 0.1 to 15 parts by mass based on a total of 100 parts by mass of the incinerator ash and the cement.

4. The phosphorus adsorbent according to claim 1, wherein the cement is included in an amount of 5 to 150 parts by mass based on 100 parts by mass of the incinerator ash, and the lanthanum is included in an amount of 0.5 to 4 parts by mass based on a total of 100 parts by mass of the incinerator ash and the cement.

5. The phosphorus adsorbent according to claim 1, wherein the phosphorus adsorbent is porous.

6. The phosphorus adsorbent according to claim 1, which is used to remove phosphorus contained in effluent.

7. A method for producing a phosphorus adsorbent, comprising granulating incinerator ash, cement, and lanthanum, using a solvent.

8. The method for producing a phosphorus adsorbent according to claim 7, wherein the incinerator ash is coal ash.

9. The method for producing a phosphorus adsorbent according to claim 7, wherein the cement is added in an amount of 5 to 150 parts by mass based on 100 parts by mass of the incinerator ash, and the lanthanum is added in an amount of 0.1 to 15 parts by mass based on a total of 100 parts by mass of the incinerator ash and the cement.

10. The method for producing a phosphorus adsorbent according to claim 7, wherein the cement is added in an amount of 5 to 150 parts by mass based on 100 parts by mass of the incinerator ash, and the lanthanum is added in an amount of 0.5 to 4 parts by mass based on a total of 100 parts by mass of the incinerator ash and the cement.

11. The method for producing a phosphorus adsorbent according to claim 7, wherein after the granulating, the granules are cured and then calcined.

12. The method for producing a phosphorus adsorbent according to claim 11, wherein the calcination temperature is 600 to 1000° C.

13. A phosphorus adsorption method comprising contacting the phosphorus adsorbent according to claim 1 with a liquid containing phosphorus.

14. A phosphorus removal method comprising adsorbing and removing phosphorus in effluent by using the phosphorus adsorbent according to claim 1.
